(19) United States
(12) Patent Application Publication
(10) Pub. No.: US 2011/0119705 A1
(43) Pub. Date: May 19, 2011

(54) Apparatus and Methods For Storing Packetized Video Content

(75) Inventor: Jeffrey John Meyers, Lilburn, GA (US)

(73) Assignee: DISH NETWORK LLC, Englewood, CO (US)

(21) Appl. No.: 12/621,149

(22) Filed: Nov. 18, 2009

(51) Int. Cl. H04N 7/26; H04H 40/00; H04N 5/445; G06F 3/00; G06F 13/00

(52) U.S. Cl. 725/37; 455/3.06; 386/E05.007

(57) ABSTRACT

A receiving device receives video content in a plurality of packets, such as internet protocol (IP) packets. The receiving device processes the packets to strip header information from the packets and stores the associated video content on a storage medium for subsequent viewing by a user.

### BRIEF DESCRIPTION OF THE DRAWINGS

The same number represents the same element or same type of element in all drawings.

FIG. 1 illustrates an embodiment of a communication network.

FIG. 2 illustrates an embodiment of a receiving device of FIG. 1.

FIG. 3 illustrates an embodiment of a process for receiving and storing video content.

### DETAILED DESCRIPTION OF THE DRAWINGS

Described herein are systems, methods and apparatus for receiving video content. More particularly, described herein are techniques for receiving packetized video content, such as video content transferred in a plurality of internet protocol (IP) packets or the like. For example, a receiving device may receive video content transmitted in accordance with the advanced television systems committee mobile/handheld (ATSC M/H) standard. The receiving device may then store the packets for subsequent viewing by a user.

At least one embodiment described herein provides a receiving device for receiving ATSC M/H video content. The receiving device includes a storage medium for storing video content. The receiving device also includes a wireless receiver that receives an ATSC M/H signal including video content. The receiving device also includes control logic communicatively coupled to the wireless receiver that concurrently coordinates storage of the video content onto the storage medium and transfers the video content to a video decoder of the receiving device. The video decoder decodes the video content and outputs the decoded video content to a presentation device for presentation to a user.

In accordance with the ATSC M/H standard, a receiving device receives video content in a plurality of packets, such as a plurality of IP packets. In at least one embodiment, the control logic strips IP headers from the IP packets prior to storage onto the storage medium. Thus, the video content is smaller for storage on a mobile device, such as a wireless telephone or the like.

Another embodiment provides a receiving device for receiving packetized content. The apparatus includes a storage medium and a receiver that receives a plurality of packets including video content. The apparatus also includes control logic communicatively coupled to the receiver that strips header information from the plurality of packets and coordinates storage of the stripped packets onto the storage medium.

Another embodiment provided herein is a method of storing video content. The method includes receiving, at a receiver, video content transmitted in a plurality of packets; stripping header information from the plurality of packets received by the receiver; and storing the stripped packets on a storage medium associated with the receiver.

Many of the embodiments provided herein are described in the context of the ATSC M/H standard. The ATSC M/H standard is a proposal for providing mobile digital television broadcasts to mobile devices, such as mobile telephones and the like. While the techniques described herein are particularly applicable for receiving and storing mobile video content, such as ATSC M/H video content, it is to be appreciated that the techniques described herein may also be applied to non-mobile video, such as ATSC video content (designated as the A/53 standard).

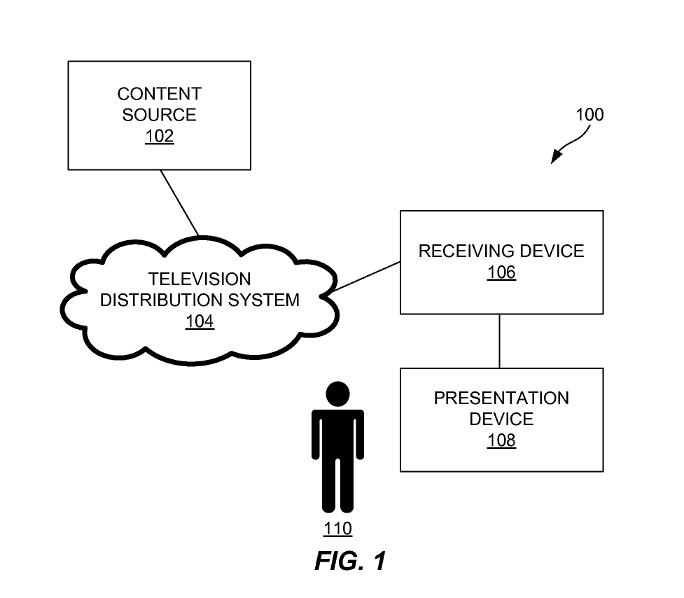

FIG. 1 illustrates an embodiment of a communication network 100. The communication network includes a content source 102, a television distribution system 104, a receiving device 106 and a presentation device 108. Each of these components will be discussed in greater detail below. The communication network 100 may include other components, elements or devices not illustrated for the sake of brevity.

The content source 102 is operable for receiving, generating and communicating content to one or more receiving devices 106. The content to be received, processed, outputted and/or communicated may come in any of various forms including, but not limited to, audio, video, data, information, or otherwise. In at least one embodiment, the content source 102 is operable for receiving various forms and types of content from other sources, aggregating the content and transmitting the content to the receiving device 106 through the television distribution system 104. It is to be appreciated that the content source 102 may receive practically any form and/or type of information from one or more sources including streaming television programming, recorded audio or video, electronic programming guide data and the like.

The television distribution system 104 is operable to transmit content from the content source 102 to the receiving device 106. The television distribution system 104 may comprise any type of wired (e.g., cable and fiber) and/or wireless (e.g., cellular, satellite, microwave, and other types of radio frequency) communication medium and any desired network topology (or topologies when multiple mediums are utilized). Exemplary television distribution systems 104 include terrestrial, cable, satellite and internet protocol television (IPTV) distribution systems. In at least one embodiment, the television distribution system 104 broadcasts or multicasts content to a plurality of television receivers, e.g., receiving device 106. The television distribution system 104 may also distribute content to a specific addressable television receiver, e.g., receiving device 106, such as video-on-demand and the like. In at least one embodiment, the content source 102 may be embodied as a transmission facility of the television distribution system 104. Exemplary content sources 102 include over-the-air (OTA) terrestrial transmission facilities, cable television distribution head-ends, satellite television uplink centers, broadband or internet servers and the like.

As described above, in at least one embodiment, the television distribution network 104 transmits content in accordance with the ATSC Mobile DTV Standard (A/153) promulgated by the Advanced Television Systems Committee of Washington D.C. In the ATSC M/H standard, video content is encoded in a portion of the total ATSC Bandwidth available for a particular television channel. The typical 6 MHZ radio frequency (RF) channel includes a total bandwidth of ˜19.4 Mbps, which may be utilized to transmit several programs on different subchannels. For example, the 6 MHZ RF channel may be utilized to simultaneously transmit an ATSC MPEG-2 encoded service (e.g., a television program) and a corresponding mobile service (e.g., a reduced resolution version of the television program) transmitted in accordance with the ATSC M/H standard. The mobile version of the program will typically be encoded at a smaller resolution to more appropriately utilize the hardware in a mobile device, such as a wireless telephone, for presentation of the content.

Unlike traditional ATSC programming, which is encapsulated at the network layer in MPEG-2 transport stream packets, the ATSC M/H video content is encapsulated at the network layer in IP packets. At the transport layer, the mobile video is encapsulated within user datagram protocol (UDP) packets and at the session layer, the video content is encapsulated within real-time transport protocol (RTP) packets. At the presentation layer, video is encoded within the MPEG-4 protocol. The Candidate Standard: ATSC-Mobile DTV Standard, available from the Advanced Television Systems Committee, dated May 29, 2009, provides more information on the transmission of ATSC M/H video content to end user devices, such as the receiving device 106.

The receiving device 106 is operable to receive content from the television distribution system 104 and store the received content for subsequent presentation to the user 110. The receiving device 106 is further operable to output the received and/or stored content for presentation by the presentation device 108. For example, the receiving device 106 may concurrently output received content for presentation by the presentation device 106 and store the video content on a storage medium for subsequent playback. In at least one embodiment, the presentation device 108 is a display device (e.g., a television) configured to display content to a user 110. The receiving device 106 may receive an audio/video stream in any format (e.g., analog or digital format), and store and output the audio/video stream for presentation by the presentation device 108.

In at least one embodiment, the receiving device 106 may be integrated with a television receiver, such as a satellite, cable, over-the-air, broadband or other type of television receiver that receives and demodulates television signals that are outputted for display on a display device (e.g., a television). The receiving device 106 may be further configured to output menus and other information that allow a user 110 to control the output of audio/video content by the receiving device 106, view electronic programming guides (EPGs), set recording timers and the like.

In some embodiments, the receiving device 106 and the presentation device 108 may be integrated as a device combining the functionality of a display device and television receiver/digital video recorder (DVR) or the like. For example, the receiving device 106 and the presentation device 108 may be integrated within a mobile communication device, such as a mobile telephone, netbook, personal digital assistant (PDA) or the like.

In at least one embodiment, the receiving device 106 concurrently stores content that the user 110 is presently watching to enable trick play modes, e.g., re-playing particular content or pausing of particular content). The receiving device 106 is also operable to record content for subsequent presentation to a user 110. Responsive to particular recording timers, the receiving device 106 coordinates the reception of video signals associated with a television program through a television receiving resource (e.g., a television tuner) and storage of the video signal onto a storage medium (e.g., a hard drive or Flash memory). The receiving device 106 may include any number of television receiving resources utilized for receiving television programs. A receiving device 106 minimally includes at least one television receiving resource to receive and record video signals associated with a television program. The receiving device 106 may include multiple television receiving resources to record multiple television programs simultaneously. For example, the receiving device 106 may include two or more tuners that allow recording and/or viewing of multiple programs through the receiving device 106 simultaneously. In at least one embodiment, the receiving device 106 may include multiple types of television receiving resources, such as an over-the-air (OTA) tuner and a satellite and/or cable television tuner that may be utilized to receive and/or record programs from multiple sources.

In at least one embodiment, the receiving device 106A is operable to strip header information from received content prior to storage or decoding. For example, a tuner may receive video content in a plurality of IP encapsulated packets and the receiving device 106 may remove the IP header information prior to storage. In at least one embodiment, the receiving device 106 may strip other layers of header information, such as UDP or RTP header information in order to more efficiently utilize the capacity of the storage medium.

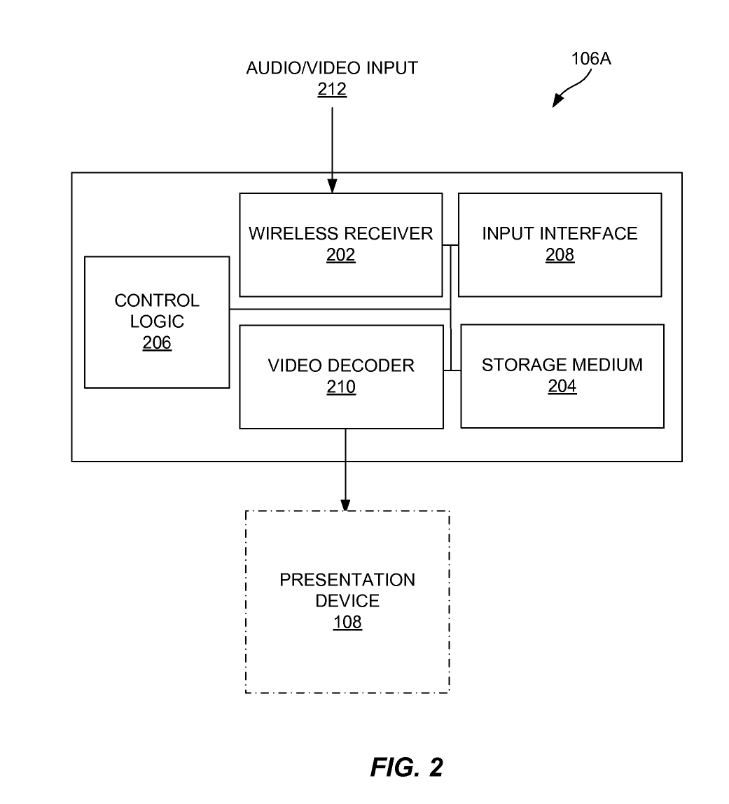

FIG. 2 illustrates an embodiment of a receiving device of FIG. 1. FIG. 2 will be discussed in reference to the communication network 100 illustrated in FIG. 1. The receiving device 106A includes a wireless receiver 202, a storage medium 204 control logic 206, an input interface 208 and a video decoder 210. Each of these components will be discussed in greater detail below. The receiving device 106A may include other elements, components or devices which are not illustrated for the sake of brevity.

The wireless receiver 202 is operable to receive an audio/video input 212 from the content source 102 (see FIG. 1). More particularly, in at least one embodiment, the wireless receiver 202 receives and tunes a television signal including television programming. The wireless receiver 202 may receive any type of video signal and tune the audio/video input 212 to extract the selected television programming. For example, the wireless receiver 202 may be operable to tune an ATSC M/H signal in order to extract video content that a user 110 (see FIG. 1) desires to view. In at least one embodiment, the wireless receiver 202 may comprise multiple tuners, utilized by the receiving device 106A to output and/or record multiple television programs simultaneously.

The storage medium 204 is operable to temporarily or persistently store video signals recorded by the receiving device 106A. The storage medium 204 may comprise any type of non-volatile memory appropriate for storing video signals recorded by the receiving device 106A. Exemplary storage mediums 204 include hard drives (e.g., magnetic memory), flash memory, battery backed up memory and the like. In at least one embodiment, the storage medium 204 may be internally located within the receiving device 106A. In other embodiments, the storage medium 204 may be located external with respect to the receiving device 106A. The receiving device 106A may also utilize a combination of internal and external storage mediums 204 for storage of video signals.

The input interface 208 is operable to receive input from a user 110 and provide the input to control logic 206 for further processing. In at least one embodiment, the input interface 208 comprises a keypad, touch screen, scroll ball/wheel or other type of man-machine interface that receives input from the user 110. In other embodiments, the input interface 208 may communicate with external input devices, such as keyboards, mice, remote controls or the like, via either wired or wireless communication links. The input received by the input interface 206 may be utilized by the control logic 206 to control the output of content by the video decoder 210. Some of the data received by the input interface 208 may request to view electronic programming guide data, menus and the like which are generated by the control logic 206.

The control logic 206 is operable to control the operation of the receiving device 106A. The control logic 206 may be a single processing device or a plurality of processing devices that cooperatively operate to control the operation of the receiving device 106A. The control logic 206 may include or be associated with various components or modules for processing and outputting audio/video content. For example, the control logic 206 may include circuitry for decrypting content received by the wireless receiver 202.

In at least one embodiment, the control logic 206 is operable to strip header information from packets received by the wireless receiver 202. For example, the control logic 206 may strip IP header information, UDP header information and/or RTP header information, depending on desired design criteria. The stripped packets may then be stored on the storage medium 204 or provided to the video decoder 210 for further processing.

The video decoder 210 receives the stripped packets and decodes compressed audio/video content contained therein to generate an output video stream which is provided to the presentation device 108. In at least one embodiment, the presentation device 212 is integrated within the receiving device 106A. For example, the receiving device 106A may comprise a mobile telephone with an integrated display screen and/or speakers capable of presenting the output stream. In at least one embodiment, the presentation device 108 may be external from the receiving device 106A and the control logic 206 may include modulator circuitry which modulates uncompressed audio/video content output by the video decoder 210 into a signal utilized by the presentation device 108.

As described above, the control logic 206 coordinates storage of the audio/video input 214 onto the storage medium 204. In at least one embodiment, the control logic 206 operates responsive to recording timers configured on the receiving device 106A to command the wireless receiver 202 to receive content from a specified channel and coordinates storage of the content onto the storage medium 204.

In at least one embodiment, the control logic 206 is operable to generate an audio/video output 216 based on the audio/video input 210, e.g., pass through the signal for display by an associated presentation device 108. The control logic 206 is also operable to retrieve stored video content from the storage medium 204 to generate an audio/video output stream for display by the presentation device 108. The presentation device 108 then presents the audio/video output stream to the user 110. The control logic 206 may incorporate circuitry to output the audio/video stream in any format recognizable by the presentation device 108, including composite video, component video, Digital Visual Interface (DVI), High-Definition Multimedia Interface (HDMI), 1394 and WiFi. The control logic 206 may also incorporate circuitry to support multiple types of these or other audio/video formats. In at least one embodiment, as described above, the receiving device 106A may be integrated with the presentation device 108, and the control logic 206 may be operable to control the presentation of the audio/video output stream by the presentation device 108.

To coordinate the storage of the audio/video input 210, the control logic 206 is operable to receive user input requesting to record one or more television programs. The control logic 206 responsively sets recording timers associated with the television programs. In some embodiments, the control logic 206 is further operable to output user interface menus and other information to allow the user 110 to view the recording timers, modify recording timers and identify recording conflicts.

In at least one embodiment, content may be simultaneously stored and output for presentation by the presentation device 108. For example, the wireless receiver 202 may receive one or more ATSC M/H packets and provide received IP packets contained therein to the control logic 206 for further processing. The control logic 206 strips the IP header information from the packets and coordinates storage of the packets into the storage medium 204. Concurrently with the storage of the packets, the control logic 206 transmits the packets to the video decoder 210 for decoding and output to the presentation device 106. Thus, a user 110 of the receiving device 106A may simultaneously view and record selected programming transmitted via the ATSC M/H standard.

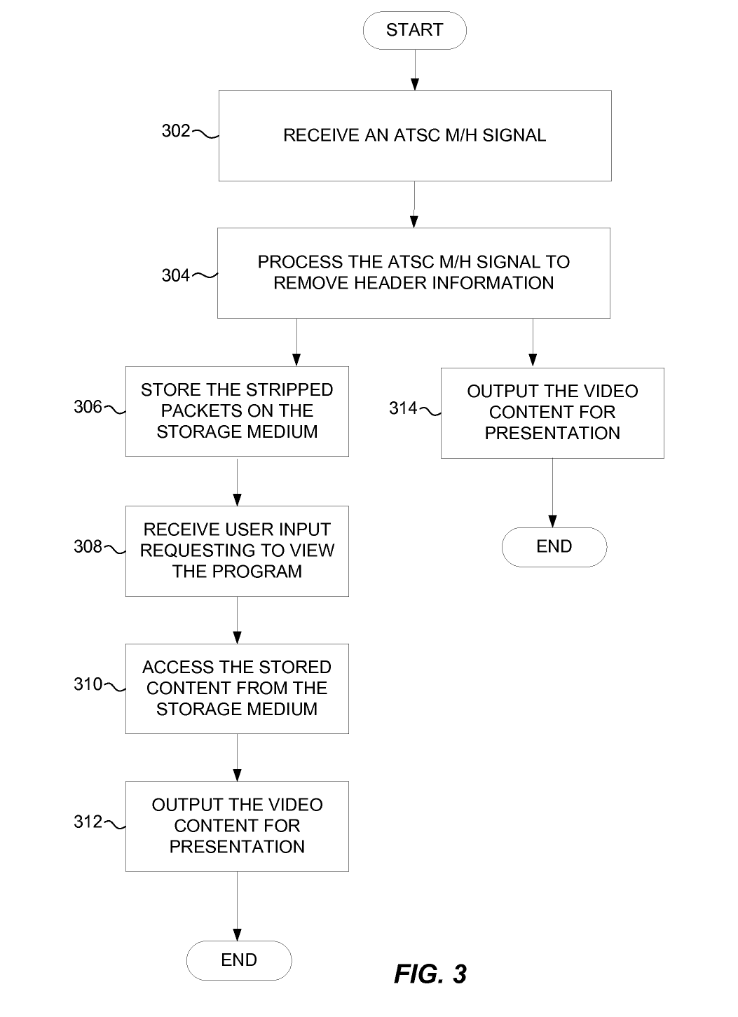

FIG. 3 illustrates an embodiment of a process for receiving and storing video content. The process of FIG. 3 will be described in reference to receiving ATSC M/H content. However, it is to be appreciated that the process may also be applied to receiving any type of packetized content. The process of FIG. 3 is not all inclusive and may include other operations not illustrated for the sake of brevity.

The process includes receiving an ATSC M/H signal from a broadcaster (operation 302). For example, a mobile telephone may include an ATSC M/H tuner that tunes and extracts mobile video content for a specified channel or event. In at least one embodiment, the tuner receives and provides to the control logic of the receiving device a plurality of IP encapsulated packets including video content received in the ATSC M/H signal.

The process further includes processing the ATSC M/H signal to strip transmission header information from the video content (operation 304). For example, the control logic may receive the IP packets and strip the IP header information from the packets. In at least one embodiment, the IP packets include UDP encapsulated data and the removal of the IP header information results in a UDP packet including video content. In at least one embodiment, the UDP header information may be stripped from the packets and the packets may be further processed as RTP packets. Thus, the UDP or RTP packets may be concurrently transferred to a video decoder for output and a storage medium for storage.

The process further includes storing the stripped packets on a storage medium of the receiving device (operation 306). For example, control logic of a receiving device may transfer the UDP packets to a storage medium (e.g., flash memory or the like) which temporarily or persistently stores the UDP packets for subsequent playback to a user.

The process further includes receiving user input requesting to view the recorded programming (operation 308). For example, the receiving device may provide a user with a menu of stored programming available for viewing through the receiving device. The user may then select a particular recorded event for viewing. In at least one embodiment, the user may be watching the program live and may desire to perform various trick play mode functions, such as replaying portions of the content or pausing the content.

The process further includes accessing the stored video content from the storage device (operation 310) and outputting the video content for presentation by a presentation device (operation 312). For example, control logic of the receiving device may request access to the stored video content and then transfer the video content to a video decoder for decoding and output to a display screen associated with the receiving device.

As described above, the processed packets generated in operation 304 may be concurrently stored and output for presentation to a user. The process also includes outputting the video content for presentation by a presentation device (operation 314). Thus, a video decoder may receive the processed packets (e.g., in UDP or RTP format) and decode the video content contained therein for output by a display screen associated with the receiving device.

Although specific embodiments were described herein, the scope of the invention is not limited to those specific embodiments. The scope of the invention is defined by the following claims and any equivalents therein.

I claim:

1. A mobile communication device comprising:
a storage medium;
a wireless receiver that receives an advanced television systems committee mobile/handheld (ATSC M/H) signal including video content;
a video decoder; and
control logic communicatively coupled to the wireless receiver that concurrently coordinates storage of the video content onto the storage medium and transfers the video content to the video decoder;
the video decoder decoding the video content and outputting the decoded video content to a presentation device.

2. The mobile communication device of claim 1, wherein the presentation device comprises a display screen integrated with the mobile communication device.

3. The mobile communication device of claim 1, wherein the control logic receives the video content in at least one internet protocol (IP) packet and strips IP headers from the IP packet prior to storage onto the storage medium.

4. The mobile communication device of claim 3, wherein the control logic further strips user datagram protocol (UDP) headers from the IP packet prior to storage onto the storage medium.

5. An apparatus comprising:
a storage medium;
a receiver that receives a plurality of packets including video content; and
control logic communicatively coupled to the receiver that strips header information from the plurality of packets and coordinates storage of the stripped packets onto the storage medium.

6. The apparatus of claim 5, further comprising:
a video decoder;
an input interface that receives user input requesting to view the video content;
the control logic coordinating retrieval of the video content from the storage medium;
the video decoder operable to decode the video content and output the decoded video content to a presentation device.

7. The apparatus of claim 5, further comprising:
a video decoder;
the control logic operable to transfer the stripped packets to the video decoder concurrently with coordinating storage of the stripped packets onto the storage medium;
the video decoder operable to decode the video content and output the decoded video content to a presentation device.

8. The apparatus of claim 5, wherein the presentation device is integrated with the apparatus.

9. The apparatus of claim 5, wherein the plurality of packets comprise a plurality of internet protocol (IP) packets.

10. The apparatus of claim 5, wherein the plurality of IP packets are transmitted in accordance with the advanced television systems committee mobile/handheld (ATSC M/H) standard.

11. The apparatus of claim 5, wherein the receiver comprises a wireless ATSC M/H receiver.

12. The apparatus of claim 5, wherein the receiver comprises a mobile communication device.

13. A method of storing video content, the method comprising:
receiving, at a receiver, video content transmitted in a plurality of packets;
stripping header information from the plurality of packets received by the receiver; and
storing the stripped packets on a storage medium associated with the receiver.

14. The method of claim 13, further comprising:
transferring the stripped packets to a video decoder concurrently with storing the stripped packets;
decoding the stripped packets into a video stream; and
outputting the video stream to a presentation device.

15. The method of claim 14, wherein the presentation device is integrated with the receiver.

16. The method of claim 13, wherein receiving the video content further comprises:
receiving the video content in a plurality of internet protocol (IP) packets.

17. The method of claim 13, wherein the plurality of IP packets are transmitted in accordance with the advanced television systems committee mobile/handheld (ATSC M/H) standard.

18. The method of claim 13, wherein the receiver comprises a mobile communication device.

19. The method of claim 18, wherein the mobile communication device comprises a mobile telephone.

20. The method of claim 13, wherein stripping header information from the plurality of packets further comprises:
stripping IP header information from the plurality of packets; and
stripping user datagram protocol (UDP) header information from the plurality of packets.
